(19) United States
(12) Patent Application Publication
(10) Pub. No.: US 2008/0277480 A1
(43) Pub. Date: Nov. 13, 2008

(54) TEMPERATURE COMPENSATED AUTO FOCUS CONTROL FOR A MICROFLUIDIC LENS, SUCH AS AUTO FOCUS CONTROL FOR A MICROFLUIDIC LENS OF A BAR CODE SCANNER

(76) Inventors: Serge Thuries, Saint Jean (FR); Jean-Louis Massieu, Montauban (FR)

Correspondence Address: PERKINS COIE LLP;PATENT-SEA, P.O. BOX 1247, SEATTLE, WA, 98111-1247, US

(21) Appl. No.: 11/747,149

(22) Filed: May 10, 2007

(51) Int. Cl. G06K 7/10

(52) U.S. Cl. 235/472.01; 359/666

(57) ABSTRACT

A system and method for adjusting the focus or zoom of a microfluidic lens assembly is described. In some cases, the system adjusts the focal length of a microfluidic lens assembly in order to compensate for the effect of temperature on the lens assembly. In some cases, the system dynamically adjusts the lens assembly in order to provide auto focusing of a bar code scanner. The system may use an open-loop system where one or more look-up-table(s) are used to quickly provide a compensation value.

### CROSS REFERENCE TO RELATED APPLICATIONS

This application is related to commonly-assigned U.S. patent application Ser. No. 11/040,485, filed on Jan. 20, 2005, entitled AUTOFOCUS BARCODE SCANNER AND THE LIKE EMPLOYING MICROFLUIDIC LENS, and commonly-assigned U.S. patent application Ser. No. ______ (attorney docket No. 110418336US), filed concurrently herewith, entitled DYNAMIC FOCUS CALIBRATION, SUCH AS DYNAMIC FOCUS CALIBRATION USING AN OPEN-LOOP SYSTEM IN A BAR CODE SCANNER, both of which are hereby incorporated by reference in their entirety.

### BACKGROUND

Closed-loop systems generally employ a feedback component that assesses the operation of the system and modifies aspects of the system based on the operational assessment. One example of such a system is a typical bar code scanner having an auto focus control system. Being closed-loop, the auto focus control system maintains or modifies the focus of optical components by analyzing images captured by the system. These systems often require long response times in refocusing a lens system, as many control and/or measurement cycles are performed during the image analysis in order to accurately determine the correct focus measurement.

Currently, bar code scanners and other machine-readable symbol imagers utilize a variety of lens actuator systems to provide auto focus control. These scanners often have problems related to the speed of correcting optical components (as described) and in the accuracy of measurement (e.g., open-loop scanners without feedback components). These and other problems exist with respect to providing auto focus control in bar code scanners.

### BRIEF DESCRIPTION OF THE DRAWINGS

FIG. 1 is a block diagram illustrating example components of a machine readable symbol reader.

FIG. 2 is a block diagram illustrating an example lens assembly of the machine readable symbol reader.

FIG. 3 is a flow diagram illustrating an example routine of focusing the lens assembly.

FIG. 4 is a flow diagram illustrating an example routine of selecting a look-up-table.

FIG. 5 is a block diagram illustrating an example of inputs used in selecting a look-up-table.

### DETAILED DESCRIPTION

Described in detail below is a system of providing auto focus control for a lens system in a bar code scanner, other machine readable symbol imaging device, camera, camcorder, or other imaging device using an open-loop control mechanism. In some examples, the system employs a lens having an electrowetting component, and actuates the lens using the electrowetting component.

In some examples described herein, the system dynamically compensates for errors due to the temperature (or other environmental factors) of the lens, employing an open-loop focus control that detects the temperature of the lens and corrects for actuation errors based on the temperature. Open loop control is generally used for well-defined, simple systems that do not require constant performance feedback in order to operate effectively. In the examples described in detail herein, the system may only correct for errors based on temperature, and not on other factors normally determined with closed-loop systems. Thus, the system is able to quickly focus the lens while maintaining an acceptable accuracy of focus, as much of the error in the focus measurements may be attributed to effects of temperature on an electrowetted lens assembly.

Various examples of the technology will now be described. The following description provides specific details for a thorough understanding and enabling description of these examples. One skilled in the art will understand, however, that the technology may be practiced without many of these details. Additionally, some well-known structures or functions may not be shown or described in detail, so as to avoid unnecessarily obscuring the relevant description of the various examples.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

### Suitable System

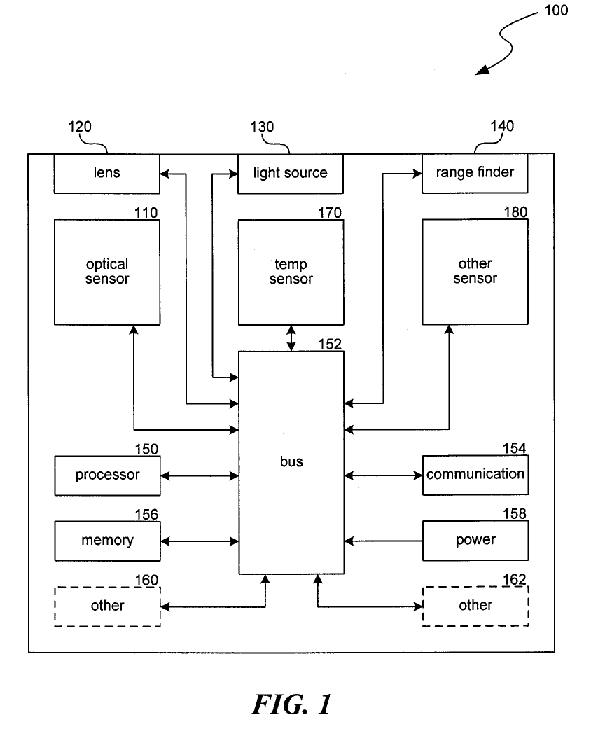

FIG. 1 and the following discussion provide a brief, general description of a suitable environment in which the technology may be implemented. Although not required, aspects of the technology are described in the general context of executable instructions, such as routines that may be executed by a general-purpose computer, hand-held scanner or imager, hand-held computer, and so on. Those skilled in the relevant art will appreciate that aspects of the technology can be practiced with other communications, data processing, or computer system configurations, including Internet appliances, other handheld devices (including personal digital assistants (PDAs)), all manner of cellular or mobile phones, embedded computers (including those coupled to vehicles), multi-processor systems, microprocessor-based or programmable consumer electronics, set-top boxes, network PCs, mini-computers, mainframe computers, and the like. Indeed, the terms “computer,” “device” and the like are generally used interchangeably and refer to any of the above devices and systems, as well as any data processor.

Aspects of the technology may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the technology may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the technology reside on another device (e.g., a server computer), while corresponding portions reside on a client computing device, such as a hand-held scanning device.

Referring to FIG. 1, a block diagram illustrating example components of an imaging device, such as a machine readable symbol reader 100, or bar code scanner, is shown. The reader 100 may include an optical sensor 110 and a lens assembly 120, such as a microfluidic lens employing electrowetting principles. The lens and optical sensor may combine to receive images of an object, such as a bar code or other machine readable symbol (e.g., universal product codes and other linear bar codes, stacked bar codes, 2D bar codes, and so on). The lens assembly may also contain an auto focus system capable of receiving information and focusing, refocusing, or defocusing the lens to a desired focal length. In some cases, the system performs focusing via an actuator, such as a microfluidic lens actuator to be described herein.

The reader 100 may include a light source 130 to illuminate an object, and may include a range finder 140 to detect distances between the reader 100 and an object. The system may use information derived from the range finder to assist in focus control or other modifications.

The reader 100 may control components and/or the flow or processing of information or data between components using one or more processors 150 in communication with memory 156, such as ROM or RAM (and instructions or data contained therein) and the other components via a bus 152. Components of the system may receive energy via power component 158 (e.g. a battery). Additionally, the system may receive or transmit information or data to other modules, remote computing devices, and so on via communication component 154. Communication component 154 may be any wired or wireless components capable of communicating data to and from reader 100. Examples include a wireless radio frequency transmitter, infrared transmitter (such as an RFID transmitter) or hard-wired cable, such as a USB cable. Reader 100 may include other additional components 160, 162 not explicitly described herein, such as additional microprocessor components, removable memory components (flash memory components, smart cards, hard drives), biometric readers, global positioning system components, printing components, and other components.

Additionally, reader 100 may include a temperature sensor 170 and/or other environmental, atmospheric or geographic sensors 180. For example, other sensors 180 may include humidity sensors, light sensors, pressure sensors, geolocation sensors, motion sensors, and so on.

Temperature sensor may interact with lens 120 (and associated actuator system) via processor 150. The temperature sensor 170 may be a number of different sensors, including resistance thermometers, thermistors, thermocouples, silicon bandgap temperature sensors, and other electrical or mechanical sensors.

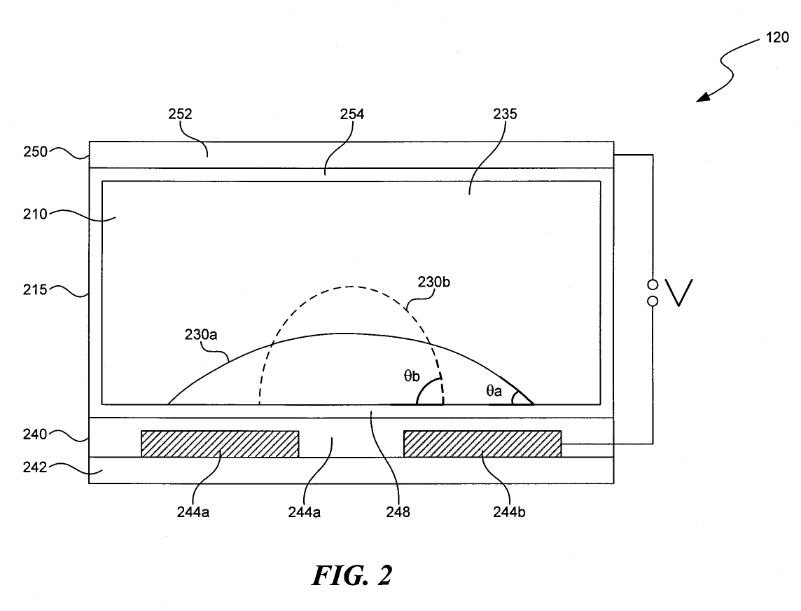

As described herein, the system may perform auto focusing of the lens assembly 120 using a microfluidic lens actuator. Referring to FIG. 2, a block diagram illustrating an example lens assembly 120 of the reader 100 is shown. Lens assembly 120 may include a cavity 210 or opening formed between opposing plates, including a bottom plate 240 and a top plate 250, and side plates 215. The cavity 210 may be filled with two immiscible liquids, such as a first liquid 230 and a second liquid 235. These liquids may have different refractive indices and be of a substantially similar density.

The bottom plate 240 may include a substrate 242, a plurality of electrodes 244a, 244b, a dielectric layer 246 that overlays the electrodes, and a hydrophobic layer 248 that provides an inner surface of bottom plate 240 in forming cavity 210. In some cases, the entire bottom plate 240 is transparent, although is some case only parts of the bottom plate 240 may be transparent. For example, the bottom plate may be formed of glass for the substrate, indium tin oxide, or ITO, for the electrodes, and a fluoropolymer for the hydrophobic layer. Other materials and configurations are of course possible.

The top plate 250 may include a substrate 252 (formed of glass or other transparent materials), and an electrode 254 (formed of indium tin oxide). As with the bottom plate 240, in some cases the top plate is formed of transparent materials and in some cases the top plate 250 may be only partially transparent.

Applying a voltage V to the electrodes (244a, 244b of the bottom plate and 254 of the top plate) causes a first potential to be applied to the first liquid 230 and a second potential to be applied to the second liquid 235. Under the principles of electrowetting, the applied voltage causes the contact between the first liquid and the hydrophobic layer to become less hydrophobic, and liquid 230 may change shape, moving from shape 230b to shape 230a. That is, a contact angle Θₐ between the liquid as shape 230a and the layer 258 is much smaller than a contact angle Θ_{b} between the liquid as shape 230b and the layer 258.

Using these principles, a simple application of voltage to the lens assembly electrodes changes the shape of liquid 230, effectively changing the focus of the lens assembly. Thus liquid 230 acts as the lens, and the system applies a voltage to the liquid to modify the lens and accurately focus an image of an object to the optical sensor 110 using liquid 230 as the lens. Further details with respect to the lens assembly 120 may be found in commonly-assigned U.S. patent application Ser. No. 11/040,485, filed on Jan. 20, 2005, entitled AUTOFOCUS BARCODE SCANNER AND THE LIKE EMPLOYING MICROFLUIDIC LENS.

For example, in order to accurately read a bar code or other machine readable symbol (an object), the system may require an accurate or clear image of the bar code to be placed on the optical sensor. Using the Gaussian Lens Equation:

1/f=1/p+1/p′

(where f is the focal length of the lens assembly, p is the lens to image distance, and p′ is the lens to object distance), the image distance, or p, depends on an accurate focal length of the lens assembly, as the only other variable is the lens to object distance. Thus, modifying the focal length f of the first liquid (in effect, changing the curvature of the liquid) using the electrowetting principles described above allows the system to modify the image distance p, enabling the system to place the image onto the optical sensor 110 with sufficient accuracy. Therefore, because the system may rely on the liquid lens for focusing, the system should be able to compensate for factors that affect the microfluidic lens assembly 120, as the microfluidic lens controls the focal length of the lens.

In some examples, in addition to a microfluidic lens component, the lens assembly may contain a number of stacked lens components (such as stacked transparent plastic lenses, glass lenses, Fresnel diffractive components, and so on) configured to provide or establish an approximately infinite object best focus distance. These lens components may provide an initial optical power for the lens assembly. The system then uses the microfluidic lens component to shorten the focal length of the lens assembly and/or shorten the object best focus distance (in some cases to 10 centimeters or smaller). Thus, the assembly provides the system with high optical power using the stacked lens components and accurate focusing using the microfluidic lens component.

Alternatively, or additionally, the system may employ other optical components when focusing the lens assembly. In some cases, the system may use a translational optical stage, nematic liquid lense, deformable mirror, and so on.

### Compensation Based on Temperature Effects

As discussed herein, the lens assembly 120 used to provide a focused image to the optical sensor 110 relies upon a liquid that changes shape when a potential is applied to the liquid. Therefore, factors that affect the shape of the liquid may affect the overall operability and accuracy of the system. Environmental factors, such as temperature, affect the shape of a liquid, especially the shape of a liquid under an applied voltage. For example, a liquid lens assembly (such as the one described) at 25 degrees C. may experience a 5 dioptre shift in optical power when placed in an environment at −25 degrees C.

Therefore, in some aspects of the system, the temperature of the lens is detected using a temperature sensor 170 in order to compensate for the effects of temperature on the liquid 230 (or the surface supporting the liquid) that controls the focus of the lens. Thus, actuation of the lens is controlled based on input received from the temperature sensor 170 and the range finder 140, enabling the system to provide an accurate and clear image to the optical sensor 110. Compensating for temperature enables the system to work within a large range of temperatures, for example, between minus 30 degrees C. to 80 degrees C.

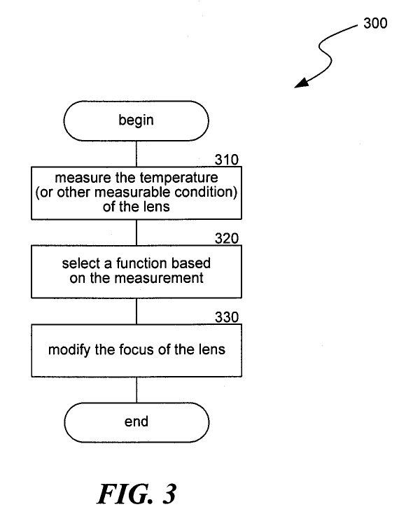

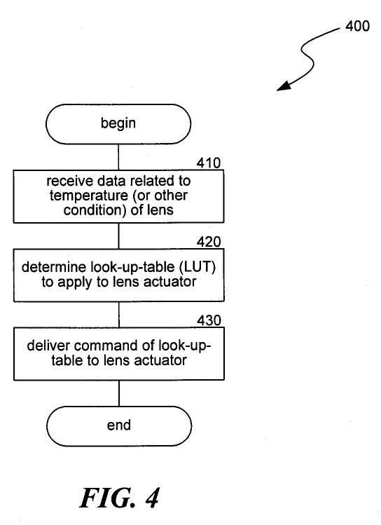

Referring to FIG. 3, a flow diagram illustrating an example routine 300 of focusing a lens assembly is shown. In step 310, the system measures the temperature of the lens assembly using a temperature sensor, such as temperature sensor 170. The temperature sensor may directly measure the temperature of the lens assembly or may measure the environment surrounding the lens assembly. In step 320, the system selects a function to apply to the lens assembly based on the measurement. For example, the system may use the range finder to determine the distance between an object to be read and the lens assembly and select a desired focal length, and may use information from the temperature sensor to determine a compensation to be applied to the desired focal length. Further aspects of selecting functions will be described with respect to FIG. 4. In step 330, the system uses the input from the range finder and the temperature sensor to determine a focal length, and modifies the focus of the lens assembly. For example, the system may reduce or strengthen the voltage applied to the electrodes of the lens assembly to achieve the desired focal length by adjusting the shape of the first liquid within the lens assembly. The system may adjust the focal length of the assembly or may adjust a zoom value of the assembly, such as the zoom value for a camera, camcorder, or other imaging device.

In some aspects, the system may constantly and/or dynamically perform routine 300 in order to maintain an accurate focus of the lens assembly. In some cases, the system may constantly measure the temperature of the lens assembly and periodically measure the distance of the object to the lens assembly. In some cases, the system may constantly measure the distance of the object to the lens assembly and periodically measure the temperature of the lens assembly. In some cases, the system may dynamically choose when to measure the distance of the object to the lens assembly and/or the temperature of the lens assembly. For example, the system may determine that the temperature has not changed (or significantly changed) after a threshold number of measurements, and determine that the temperature is remaining constant. The system may then only measure temperature when the system detects an error in reading a symbol object or several errors within a pre-defined or dynamically defined window, which may signify a subsequent change in temperature.

The system may apply a number of different functions to the lens assembly in order to focus or defocus the lens assembly. Referring to FIG. 4, a flow diagram illustrating an example routine 400 of selecting a look-up-table or an entry in a look-up-table to be applied to a lens assembly is shown. In step 410, the system receives data related to the temperature of the lens assembly. Using the temperature information and range finder information, the system, in step 420, selects a look-up-table to be applied to the actuator of the lens assembly. The look-up-table, or LUT, may be a data structure, such as an array, that provides a simplified and/or quick lookup operation of a value for the focal length that corresponds to information provided by the range finder, information provided by the temperature sensor, or both. Of course, the system may employ other computations in determining the value for the focal length, such as runtime computations employing appropriate temperature compensating algorithms, based on received information.

In step 430, the system applies the value retrieved using the LUT to the actuator, and automatically focuses (or refocuses) the lens assembly with the retrieved value. That is, the system, upon receiving the value from a look-up-table, adjusts the voltage applied to the microfluidic lens, causing the lens assembly to change focus. In some cases, the retrieved value will be close to the value at the lens assembly, and the system may not change the focus.

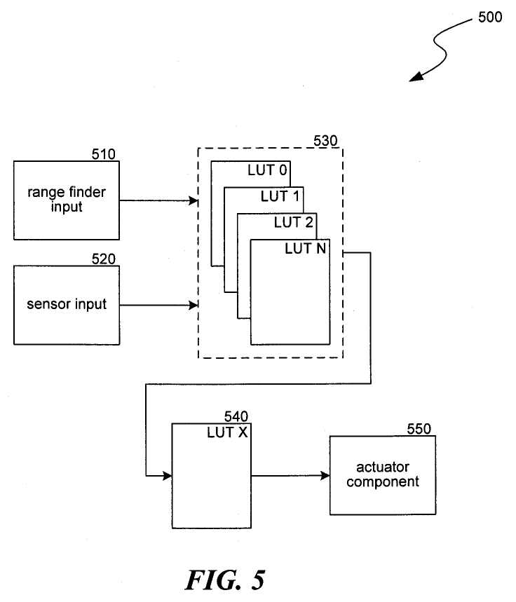

Referring to FIG. 5, a block diagram 500 illustrating an example of inputs used in selecting a look-up-table is shown. The system may receive input from one or more open-loop control mechanisms, such as from a range finder, temperature sensor, geographic or location sensor, and so on. For example, the system may receive input from the range finder 510 (providing a lens to object distance input) and from one or more environmental sensors, such as input from a temperature sensor 520 (providing a temperature of the lens assembly). Using the inputs 510, 520 received from open-loop control components, the system may look to a collection 530 of look-up-tables 0 through N. The system may match information from the inputs 510, 520 and select a look-up-table 540 that represents characteristics of the system. The system may then apply look-up-table 540 to an actuator component 550 that controls the actuation of the lens assembly. In some cases, the actuator component 550 may modify the focal length f of the lens assembly by modifying the voltage applied to the first liquid of the assembly. In some cases, the system may translate the lens assembly closer to or further away from the object, modifying the lens to object length p′.

Thus, the system provides an auto focused, temperature compensated microfluidic lens assembly capable, in some cases, of quickly and accurately reading machine readable symbols with few errors, as well as providing additional benefits.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,“or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the technology is not intended to be exhaustive or to limit the technology to the precise form disclosed above. While specific embodiments of, and examples for, the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the technology.

These and other changes can be made to the technology in light of the above Detailed Description. While the above description describes certain embodiments of the invention, and describes the best mode contemplated, no matter how detailed the above appears in text, the technology can be practiced in many ways. Details of the data collection and processing system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the invention with which that terminology is associated. In general, the terms used in the following claims should not be construed to limit the technology to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. For example, while only one aspect of the system is recited as embodied in means-plus-function form under 35 U.S.C. §112, sixth paragraph, other aspects may likewise be embodied in means-plus-function form in future claims. Accordingly, the inventors reserve the right to add additional claims after filing the application to pursue such additional claim forms for other aspects of the system.

We claim:

1. A hand-held device configured to read machine readable symbols, comprising:
a lens assembly having an adjustable focal length, wherein the lens assembly includes a liquid whose shape is determined based on a voltage applied to the liquid;
a range finder, wherein the range finder determines a distance between the hand-held device and a selected machine readable symbol;
a temperature sensor, wherein the temperature sensor measures a temperature of the lens assembly; and
a dynamic adjustment component coupled to the lens assembly, range finder, and temperature sensor, wherein the dynamic adjustment component adjusts the focal length of the lens assembly based on information received from the range finder and the temperature sensor and without receiving closed-loop feedback.

2. The device of claim 1, wherein the lens assembly includes:
a bottom plate, wherein the bottom plate includes a substrate layer, one or more electrodes, and a hydrophobic layer that provides a surface for the liquid; and
a top plate, wherein the top plate includes a substrate layer and an electrode;
wherein the bottom plate and top plate form a cavity that contains the liquid.

3. The device of claim 1, wherein the lens assembly includes:
an adjustable lens component containing the liquid; and
one or more additional lens components configured to provide a substantially infinite object focus distance.

4. The device of claim 1, wherein the dynamic adjustment component adjusts a distance between the hand-held device and a selected machine readable symbol based on the information received from the range finder and the temperature sensor.

5. The device of claim 1, wherein the dynamic adjustment component selects a look-up-table from a database of one or more look-up-tables based on the information received from the range finder and the temperature sensor.

6. The device of claim 1, wherein the range finder determines a distance between the hand-held device and a selected machine readable symbol and the temperature sensor measures a temperature of the lens assembly in response to receiving an indication of an error in reading the symbols.

7. A lens assembly for an imaging device capable of capturing machine readable symbols or other objects, comprising:
a lens component, wherein the lens component includes a cavity housing a liquid, and wherein the liquid changes shape in response to an applied voltage; and
an actuation component, wherein the actuation component receives data related to a temperature of the liquid or related to an environmental temperature proximate to the liquid and modifies the applied voltage based on the received temperature data to compensate for errors due to temperature effects.

8. The lens assembly of claim 7, wherein the actuation component receives data related to a distance between the imaging device and a target object and modifies the applied voltage based on the received distance data.

9. The lens assembly of claim 7, wherein the actuation component receives data related to a location of the imaging device and modifies the applied voltage based on the received location data.

10. The lens assembly of claim 7, wherein the actuation component receives data related to a location and time of day of the imaging device and modifies the applied voltage based on the received location and time of day data.

11. The lens assembly of claim 7, wherein the liquid changes shape in order to adjust a focal length of the lens assembly.

12. The lens assembly of claim 7, further comprising:
a temperature sensor that provides the data related to a temperature of the liquid.

13. A method of dynamically adjusting a focal length or zoom value of a lens assembly, the method comprising:
automatically determining a location characteristic of the lens assembly, wherein the location characteristic of the lens assembly is determined with a sensor associated with the lens assembly;
automatically determining an adjusted value for the focal length or zoom value of the lens assembly, wherein the adjusted value corresponds to the determined location characteristic; and
automatically modifying the focal length or zoom value of the lens assembly to the adjusted value.

14. The method of claim 13, further comprising:
automatically measuring a distance between a machine readable code located proximate to the lens assembly, and
automatically determining the adjusted value, wherein the adjusted value corresponds to the determined location characteristic and the measured distance.

15. The method of claim 13, wherein the determined location characteristic comprises a temperature of the lens assembly.

16. The method of claim 13, wherein the determined location characteristic comprises a temperature of an environment proximate to the lens assembly.

17. The method of claim 13, wherein the determined location characteristic comprises a geographical location of the lens assembly.

18. The method of claim 13, wherein determining an adjusted value for the focal length or zoom value comprises selecting a look-up-table related to the determined location characteristic.

19. A computer-readable medium whose contents cause an image capture device to perform a method of compensating for an error in imaging an object due to location characteristic effects on an optical system of the image capture device, the method comprising:
gathering information related to characteristics of a location of the image capture device, wherein the information is gathered using an open-loop feedback system of the image capture device;
retrieving a compensation value from an array of compensation values, wherein the compensation value relates to the characteristic information of the location; and
adjusting a parameter of the optical system based on the retrieved compensation value, wherein the parameter adjustment reduces the error in imaging the object.

20. The computer-readable medium of claim 19, wherein the array comprises one or more look-up-tables.

21. The computer-readable medium of claim 19, wherein the characteristic location information relates to a temperature of the location, and wherein retrieving a compensation value comprises retrieving a look-up-table corresponding to the temperature of the location.

22. The computer-readable medium of claim 19, further comprising:
measuring a distance between the optical system and the object, and adjusting the parameter of the optical system based on the measured distance.

23. The computer-readable medium of claim 19, wherein adjusting the parameter of the optical system comprises adjusting a focal length of the optical system.

24. The computer-readable medium of claim 19, wherein adjusting the parameter of the optical system comprises adjusting a zoom value of the optical system.

25. The computer-readable medium of claim 19, wherein the optical system comprises a microfluidic lens assembly, and wherein adjusting the parameter of the optical system comprises adjusting a focal length of the microfluidic lens assembly.

26. An apparatus for dynamically adjusting a focal length or zoom value of a lens assembly, comprising:
a means for determining a characteristic of a location of the lens assembly,
a means for determining an adjusted value for the focal length or zoom value of the lens assembly, wherein the adjusted value corresponds to the determined location characteristic; and
a means for automatically modifying the focal length or zoom value of the lens assembly to the adjusted value.
